(19) United States
(12) Patent Application Publication
(10) Pub. No.: US 2010/0274824 A1
(43) Pub. Date: Oct. 28, 2010

(54) Portable storage device with subject identification and method thereof

(75) Inventors: Chaucer Chiu, Taipei (TW); Jiuying Zhao, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/453,018

(22) Filed: Apr. 28, 2009

(51) Int. Cl. G06F 12/00; G06F 12/14; G06F 17/30; G06F 21/00

(52) U.S. Cl. 707/812; 726/19; 707/E17.01; 707/E17.044; 711/E12.001

(57) ABSTRACT

This specification discloses a portable storage device with subject identification and the method thereof. When data are stored to the portable storage device or read from the portable storage device by other terminals, the portable storage device identifies the data subject. This solves the problem of unable to identify the subject during the data storing or reading step in the prior art. Therefore, the stored data subject can be immediately identified. The invention further achieves the goal of letting several people sharing one portable storage device.

### BACKGROUND OF THE INVENTION

1. Field of Invention

This invention relates to a portable storage device with subject identification and the method thereof. In particular, the invention relates to a portable storage device that performs subject identification according to user's inputs.

2. Related Art

In pursuit of speed and convenience, many electronics have become more compact in order to achieve higher efficiencies. This trend is seen in vehicles, computer elements, and mobile phones. Besides, the portable storage devices such as memory sticks and mobile hard drives (HDs) are particularly designed to be light.

The primary function of a portable storage device is to enable a user to carry data. It also serves as a convenient medium for transmitting data among various terminals. For example, most of current medical measuring devices have the USB interface. A user can link a portable storage device with the medical measuring device to temporarily store the data generated thereby in the portable storage device. The user can then carry the stored data to another terminal for further analyses.

However, saving the data into the portable storage device is a simple transfer. It can not further tag to which subject the data belongs. Therefore, if many people share the same medical measuring device, the most common method to distinguish the subjects is each person uses his/her own portable storage device. The data are then distinguished while reading at terminals. However, when many people use their own portable storage devices to store data measured by the same medical measuring device in the same environment, it is inevitable that somebody may lose his/her portable storage device. This may be because the portable storage devices are too similar in their outlooks. This can result in the mistake of saving one person's medical data in another person's portable storage device.

For example, if this happens in a hospital where people share the same medical measuring device, then the stored data can only be distinguished after they are read out at a terminal. If nobody notices this mistake, then the data are sent to the terminal for analyses. Not only do those data provide no reference value to the person, they even cause incorrect medical diagnoses. Besides, if the person has to bring the measured data to a terminal at somewhere else for further analyses, then people generally need more portable storage devices. This is very uneconomical. For example, if a hemomanometer is shared in a four-person ward, then four portable storage devices are needed in order to store four people's data separately for further analyses at other places. If the four people share the same portable storage device, then it has to be taken to a terminal for an immediate analysis each time somebody's data are stored, so that there will be no confusion in subsequent uses.

In summary, the prior art always has the problem that it cannot perform subject identification during the step of saving or reading data to or from the portable storage device. It is therefore imperative to provide a solution.

### SUMMARY OF THE INVENTION

In view of the foregoing, the invention discloses a portable storage device with subject identification and the method thereof.

The disclosed portable storage device with subject identification can transfer data measured by a measuring device to a terminal. It includes an external port, multiple data folders, a receiving module, a verifying module, and an accessing module. The external port enables the connection with a measuring device or terminal, as a transmission port of the measured data. The folders have their own names for storing the measured data by the measuring device. The receiving module receives a user's folder name for subsequent verification. The verifying module sends a verification request when connecting with the measuring device or the terminal. It uses the folder name received by the receiving module to find the corresponding folder. The accessing module stores the measured data to the folder via the external port, and accepts the editing on the measured data stored in the folder by the terminal.

The disclosed method of subject identification in a portable storage device transfers the measured data by a measuring device to a terminal. First, the portable storage device is established with many folders, each of which has a folder name. After the portable storage device is connected with the measuring device, it sends a verification request. When a folder name entered by the user according to the verification request is received, it is used to find a corresponding folder. The measured data by the measuring device are received and stored to the folder. The portable storage device connects to a terminal, and also sends a verification request. When a folder name entered by the user according to the verification request, it is used to find a corresponding folder. The terminal then edits the measured data stored in the folder.

The system and method as described above differ from the prior art in that the invention involves the technique of selecting the data subject during the step of storing or reading data. Using this technique, the invention can immediately identify the subject associated with the stored data. This enables multiple people to share the same portable storage device.

### BRIEF DESCRIPTION OF THE DRAWINGS

The invention will become more fully understood from the detailed description given herein below illustration only, and thus is not limitative of the present invention, and wherein:

FIG. 1 is a schematic block diagram of the disclosed portable storage device with subject identification;

FIG. 2 is a flowchart showing the steps in the disclosed method of subject identification for a portable storage device; and

FIG. 3 schematically shows the appearance of the disclosed portable storage device with subject identification.

### DETAILED DESCRIPTION OF THE INVENTION

The present invention will be apparent from the following detailed description, which proceeds with reference to the accompanying drawings, wherein the same references relate to the same elements.

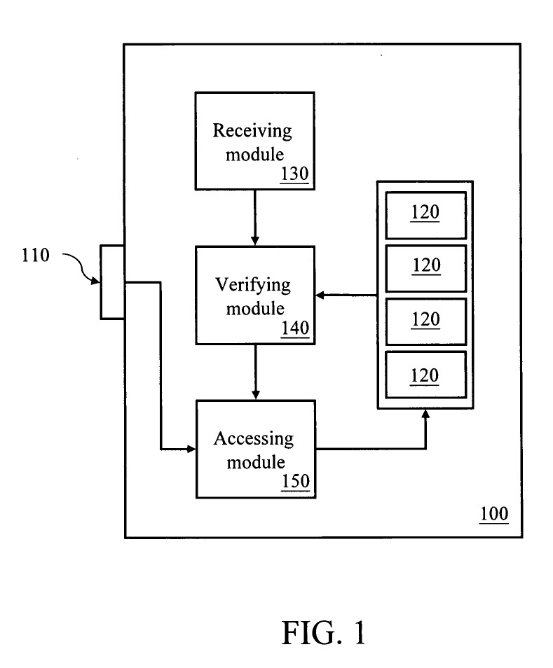

FIG. 1 is a schematic block diagram of the disclosed portable storage device with subject identification. The portable storage device with subject identification 100 carries data measured by a measuring device (not shown) to a terminal (not shown). The measuring device referred herein includes a medical measuring device, fitness device, and another apparatus with measuring functions. As an explicit example, this embodiment uses a medical measuring device and the medical data generated by it to explain the invention.

The portable storage device with subject identification 100 includes an external port 110, multiple folders 120, a receiving module 130, a verifying module 140, and an accessing module 150. In particular, the external port 110 as the transmission port for inputting or outputting the medical data, connects the portable storage device with subject identification 100 to the medical measuring device or terminal. The folders 120 store the medical data produced by the medical measuring device. Each of the folders 120 has its own folder name that can be the user's self-defined name or account (e.g., ‘Chris’). To make sure the uniqueness in subsequent subject identification, the folder names of the folders 120 have to be distinct.

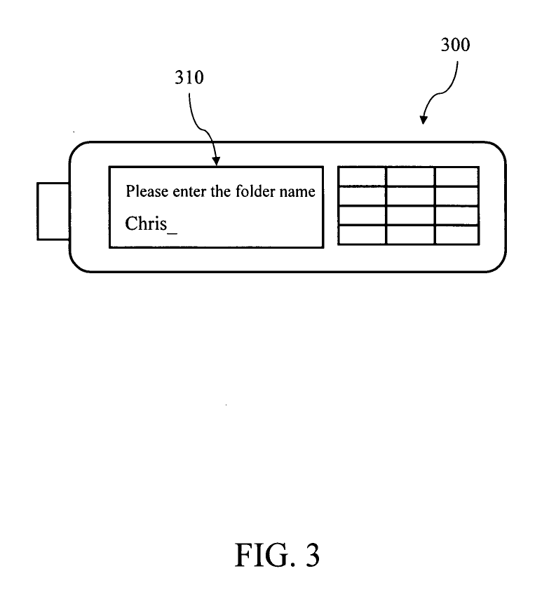

When the portable storage device with subject identification 100 connects to a medical measuring device or terminal, its verifying module 140 sends out a verification request. The verification request can be displayed on the external display device 310 of the portable storage device 300, as shown in FIG. 3. The receiving module 130 receives a folder name entered by the user according to the verification request, such as ‘Chris’. The verifying module 140 uses the folder name to find a folder 120. When some folder 120 is confirmed to have the same folder name, the accessing module 150 stores the medical data generated by the medical measuring device to the confirmed folder 120 via the external port 110 or allows the terminal to edit the medical data stored in the confirmed folder 120. When the verifying module 140 finds no folder with the desired folder name, the accessing module 150 does not allow any data storing or reading action.

Besides, the verifying module 140 has predetermined verifying passwords for the corresponding folders. After the verifying module 140 uses the folder name to find the folder 120, it further find the corresponding verifying password for further verification. For example, the verifying module 140 can display the request of further verification on the external display device 310 (FIG. 3). After the receiving module 130 receives the string entered by the user for the verification, the verifying module 140 compares it with the predetermined verification password. Only when the comparison result is correct, will subsequent accesses to the folder 120 be granted; otherwise, no data storing or reading is allowed.

The above-mentioned further verification can be implemented through questions and answers. The verifying module 140 has predetermined verification detail and question corresponding to each folder. The detail can be text, a string, or some notation. When the verifying module 140 uses the folder name to find the folder 120, it further sends out the verification question. After the receiving module 130 receives the input/selection response from the user for the verification question, the response is compared with the verification detail. The comparison result is then used to determine whether subsequent access actions are allowed.

Suppose the entered folder name is ‘Chris’. After the verifying module 140 confirms that there is a folder 120 named ‘Chris’, it finds the verification question and detail corresponding to the folder ‘Chris’. They are ‘What is your favorite color?’ and ‘blue’, respectively. The verifying module 140 shows this verification question on the external display device 310 (see FIG. 3). When the receiving module 130 receives the response for the verification question, it compares the response with the verification detail. Once the response and the verification detail are both verified to be ‘blue’, external data access to the folder 120 ‘Chris’ is granted.

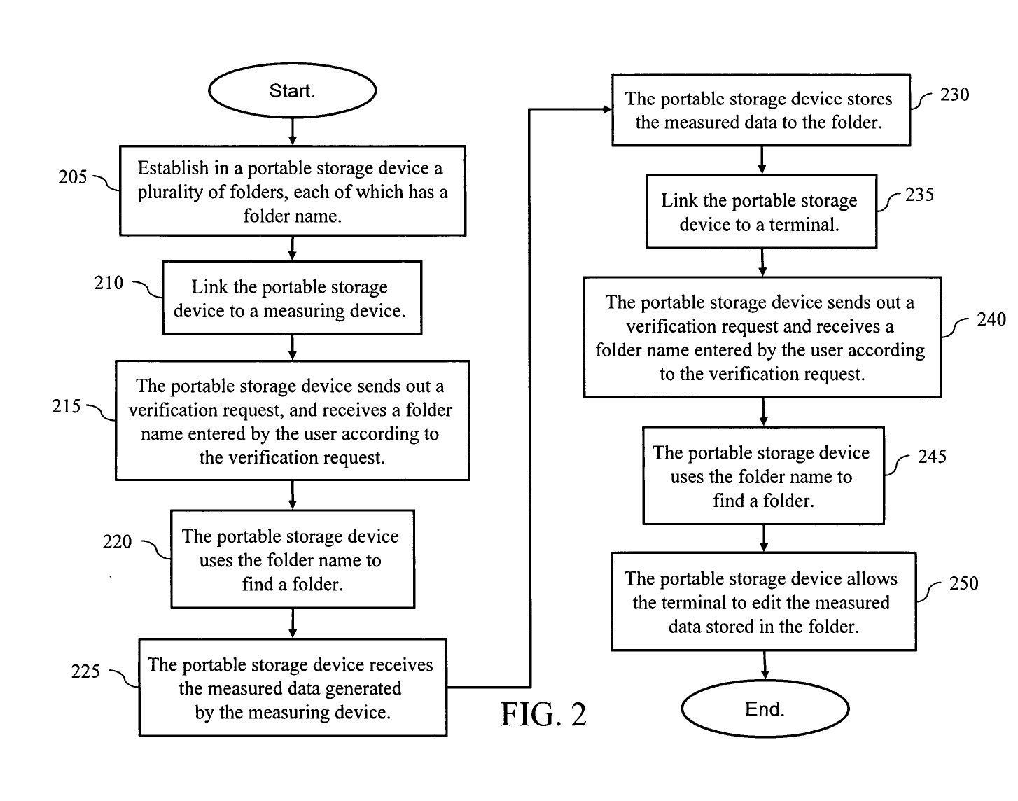

FIG. 2 is a flowchart of the disclosed method of subject identification for a portable storage device according to the invention. It is used to transfer the medical data generated by a medical measuring device to a terminal. With reference to FIG. 2, a portable storage device 100 is first established with several folders 120, each of which has a folder name (step 205). When the portable storage device 100 connects to a medical measuring device (step 210), it sends out a verification request. After the portable storage device 100 receives a folder name entered by the user according to the verification request (step 215), it further finds a folder 120 using the folder name (step 220) and receives the medical data generated by the medical measuring device (step 225). The medical data are stored in the folder 120 (step 230). When the portable storage device 100 connects to a terminal (step 235), it also sends out a verification request. When the user enters a folder name according to the verification request (step 240), the folder name is used to find a corresponding folder 120 (step 245). It then allows the terminal to edit the medical data stored in the folder 120 (step 250).

In the step of finding a folder 120 in the portable storage device 100 (step 220 and step 245), there is further the step of further verification using the predetermined password for each of the folders in the portable storage device 100. So after the portable storage device 100 uses the folder name to find the folder 120, it further finds the verification password corresponding to the folder. After a string entered by the user is received, it is compared with the verification password. If the comparison result is correct, subsequent access actions to the folder 120 are allowed; otherwise, no further data storing or reading is granted.

Moreover, the invention can predetermine verification questions and details for the folder names in the portable storage device for further verification. When the portable storage device 100 verifies that there is a folder 120 with the folder name, it sends out the predetermined question for the folder name. After receiving the response to the verification question, it compares the response with the verification detail corresponding to the folder name. Data storing or reading actions to the folder 120 are granted only when the portable storage device 100 confirms that the response and the verification detail corresponding to the folder name are the same.

In summary, the invention differs from the prior art in that it has the technique to select the subject of data during the step of data storing or reading. This technique thus solves the problems in the prior art, and enables multiple people to share the same portable storage device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A portable storage device with subject identification for transferring measured data generated by a measuring device to a terminal, the portable storage device comprising:
an external port, which links to the measuring device or the terminal as a transmission port for the measured data;
a plurality of folders for storing the measured data, each of which has a folder name;
a receiving module, which receives a folder name entered by the user according to the subsequent verification request;
a verifying module, which sends out a verification request when connected with the measuring device or terminal, and uses the folder name received by the receiving module to find a folder; and
an accessing module, which stores the measured data to the folder via the external port and allows the terminal to edit the measured data stored in the folder.

2. The portable storage device with subject identification of claim 1, wherein the folder name is a distinct personal name or account name.

3. The portable storage device with subject identification of claim 1, wherein after the folder is found, the verifying module uses a predetermined verification password associated with the folder name to perform further verification, the verification result determining whether subsequent access actions are granted.

4. The portable storage device with subject identification of claim 1, wherein the verifying module sends out a predetermined verification question associated with the folder name, receives a response to the verification question, and compares the response with a predetermined verification detail, the comparison result determining whether subsequent access actions are granted.

5. The portable storage device with subject identification of claim 4, wherein the verification detail is text, string or notation.

6. A method of subject identification for a portable storage device to transfer measured data generated by a measuring device to a terminal, the method comprising the steps of:
establishing a plurality of folders in the portable storage device, each of which has a folder name;
linking the portable storage device to the measuring device;
sending a verification request from the portable storage device and, after receiving a folder name entered by the user according to the verification request, executing the steps of:
finding a folder using the folder name by the portable storage device;
receiving the measured data by the portable storage device; and
storing the measured data to the folder by the portable storage device;
linking the portable storage device with a terminal; and
sending a verification request from the portable storage device and, after receiving a folder name entered by the user according to the verification request, executing the steps of:
finding a folder using the folder name by the portable storage device; and
allowing the terminal to edit the measured data stored in the folder.

7. The method of claim 6, wherein the folder name is a distinct personal name or account name.

8. The method of claim 6 further comprising the step of using a predetermined verification password associated with the folder name for further verification by the portable storage device after the folder is found.

9. The method of claim 6 further comprising the steps of, after the portable storage device finds the folder:
sending out a predetermined verification question associated with the folder name by the portable storage device; and
after a response to the verification question is received, verifying the response is the same as a predetermined verification detail by the portable storage device.

10. The method of claim 9, wherein the verification question is text, string, or notation.
